(19) United States
(12) Patent Application Publication
(10) Pub. No.: US 2007/0164673 A1
(43) Pub. Date: Jul. 19, 2007

(54) Organic electro-luminescent display device and method for making same

(75) Inventor: Min-Chieh Hu, Shan Hua Chen (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/334,893

(22) Filed: Jan. 18, 2006

(51) Int. Cl. H05B 33/04; H01J 1/62

(52) U.S. Cl. 313/512

(57) ABSTRACT

A display device having an electroluminescent display element disposed on a surface of a substrate and a scratch resistant layer disposed over or surrounding the display element. The scratch resistant layer has a hardness level of at least 2.5 on Moh's hardness scale. Additionally, a moisture and oxygen barrier is disposed between the display element and the scratch resistant layer. An adhesive material can be used to secure the scratch-resistant layer to the display device and to provide a hermetic seal to the display element. Preferably, the thickness of the scratch-resistant layer is equal to or greater than 10 μm.

### TECHNICAL FIELD OF THE INVENTION

The present invention relates generally to a display device having organic light emitting diodes (OLEDs) or polymeric light emitting diodes (PLEDs) as light emitters. More specifically, the present invention relates to a method for encapsulating such display devices.

### BACKGROUND OF THE INVENTION

Organic light emitting diodes (OLEDs) and polymeric light emitting diodes (PLEDs) are becoming increasingly popular for applications such as display, illumination, and backlighting. The heart of a typical organic flat panel display device is a two-dimensional pixel array disposed on a flat, transparent substrate. As shown in FIG. 1, the pixel array is typically constructed by depositing, on a substrate 10, an anode layer 26 made of a transparent conductive thin film, such as indium tin oxide (ITO), several layers of organic electro-luminescent materials 24, and a cathode layer 22. When a voltage is applied between the anode and the cathode, visible light emits from the electro-luminescent materials. Light emitted by the pixel array is transmitted through the transparent anode 26 and the substrate 10.

Because of the intrinsic properties of the materials, the pixel array of the above construction is highly susceptible to deterioration caused by oxygen and water vapor. For that reason, it has become common practice to construct a protective cover 30 on the pixel array, preferably encapsulating the pixel array. The protective cover may comprise one or more layers of inorganic or organic materials such as silicon oxides, silicon nitrides and polymers. With the protective cover properly disposed on the light-emitting materials, the display device is, to a certain extent, protected against air and moisture.

Various encapsulation structures are known in the art. For example, Graff et al (U.S. Pat. No. 6,573,652) discloses a display device encapsulated with a barrier stack comprising barrier layers and polymer layers. The barrier layers are disposed adjacent to the display device with a thickness of 100-400 Å, and the polymer layers are disposed adjacent to the barrier layers with a thickness of 1000-10,000 Å. Biebuyck et al. (U.S. Pat. No 5,895,228), Affinito (U.S. Pat. No. 6,268,695), Terasaki et al. (U.S. Pat. No. 6,432,516) and Silvernail et al. (U.S. Pat. No. 6,597,111) also disclose similar layers of protective material disposed on top of the active layers of display devices.

The main purpose of having the protective cover encapsulating the display device, as disclosed in prior art, is to protect the environmentally sensitive display materials against moisture and oxygen in the air. The protective cover in the prior art display devices, however, is not suitable for protecting the light emitting elements in the display device from accidental physical damages, especially during the manufacturing processes.

Thus, it is advantageous and desirable to provide a method to protect a display device having a light-emitting layer from physical damages caused by the scratching by finger nails, dust particles, and metal debris, for example.

### SUMMARY OF THE INVENTION

A display device, according to the present invention, has a protective structure for protecting the light emitting elements against physical damages. The display device comprises a substrate, an electroluminescent display element disposed on the substrate, one or more layers of barrier against moisture and harmful gaseous elements, and a scratch resistant layer to protect the display element and the barrier from physical damages. The scratch resistant layer can be made of metals, high polymers, glasses and ceramics such that the hardness of the scratch resistant layer is equal to or greater than 2.5 on Moh's scale of hardness. Preferably, the thickness of the scratch resistant layer is equal to or greater than 10 μm.

### BRIEF DESCRIPTION OF THE DRAWINGS

The above and other objects, features and advantages of the invention will become apparent upon reading the description taken in connection with accompanying drawings, in which:

FIG. 1 is a schematic cross sectional view of a typical electroluminescent display device;

FIG. 2 is a schematic cross sectional view of an exemplary electroluminescent display device with a scratch-resistant layer, according to a first embodiment of the invention;

FIG. 3 is a schematic cross sectional view of an exemplary electroluminescent display device with a scratch-resistant layer, according to a second embodiment of the invention;

FIG. 4 is a schematic cross sectional view of an exemplary electroluminescent display device with scratch-resistant layer, according to a third embodiment of the invention; and

FIG. 5 is a schematic representation of an electroluminescent display with a plurality of pixels arranged in a two-dimensional array.

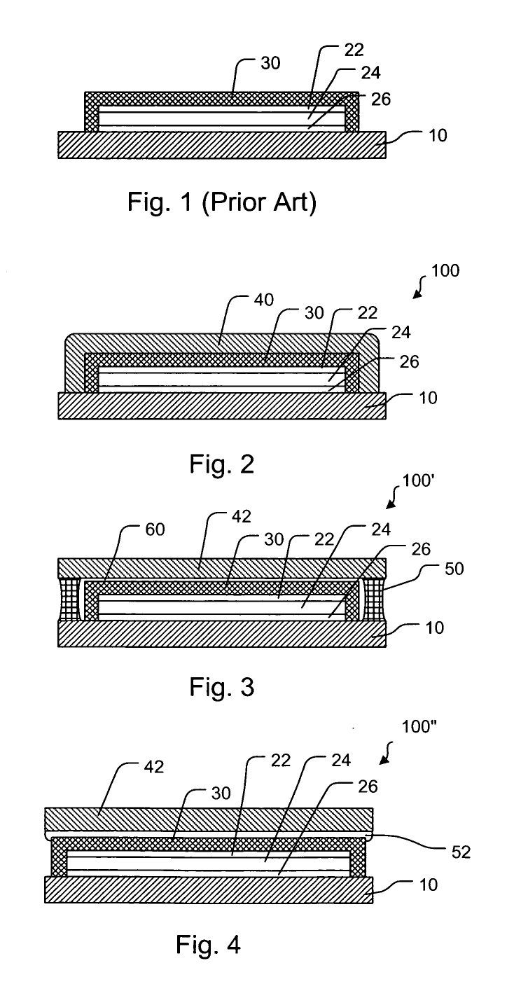

### DETAILED DESCRIPTION OF THE INVENTION

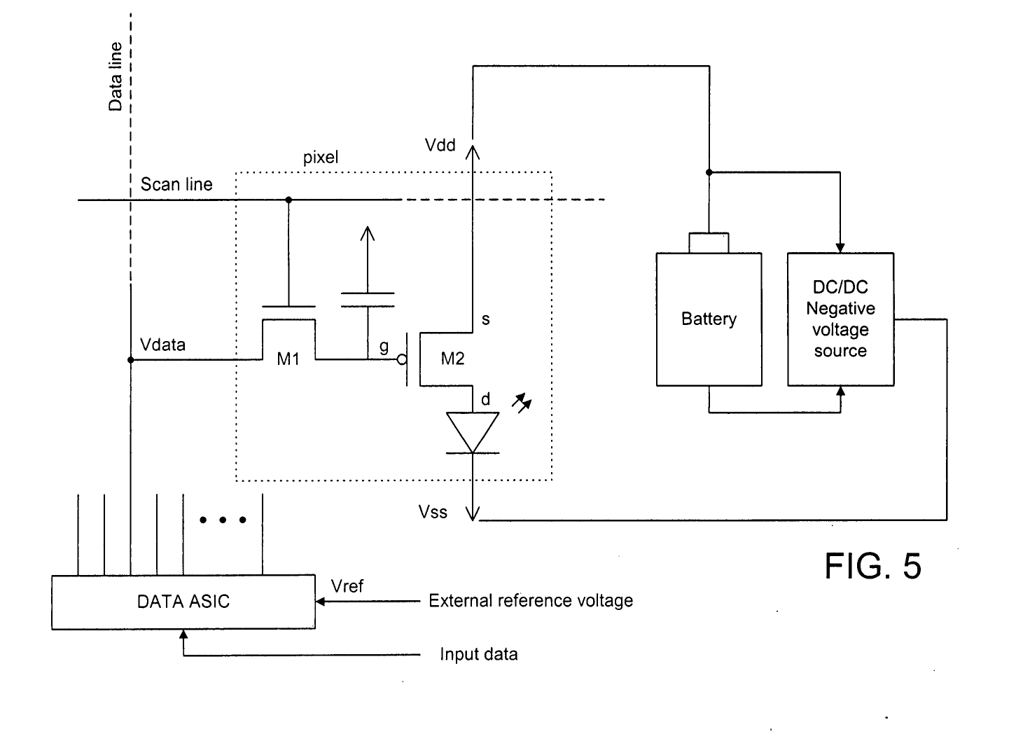

The electroluminescent display device, according to the present invention, comprises a scratch resistant layer as a part of a protective structure encapsulating the active display materials of the device. A schematic representation of the electroluminescent display device is shown in FIG. 5. The material suitable for the scratch resistant layer has a hardness level of at least 2.5 on Moh's scale of hardness. The invention is further explained in the following exemplary embodiments.

First Embodiment of the Invention

The first embodiment of the invention is shown in FIG. 2. As shown, the display device 100 has a substrate 10 and an electroluminescent display element (26, 24, 22) disposed on the substrate. The display element is known in the art as described in the background section, and schematically shown in FIG. 5. Typically it comprises an anode 26 made of a transparent material, such as indium tin oxide, a plurality of active layers 24 to produce electroluminescence, and a cathode layer 22. One or more layers of thin film 30 are disposed above and surround the layered structure, forming a barrier against moisture and air. One or more layers of scratch-resistant material is disposed above and surrounding the barrier thin film layers 30 to form a protective cover 40. Such material, when formed, must have a hardness level at least 2.5 on Moh's scale of hardness, and the thickness of scratch resistant layer is preferably greater than 10 μm so as to protect the barrier thin film layers 30 and the electroluminescent layered structure against physical damages. Since the thickness of the cover must be sufficient to ensure the hardness requirement, it may be significantly thicker than the protective thin films. The thickness of the protective cover 40 is preferably greater than 10 μm. Numerous dense and hard solid materials may be used, such as metals, glasses, ceramics, polymers and epoxy resins. Coupling of this cover to the barrier thin film layers 30 and the substrate 10 can be achieved by adhesion, chemical vapor deposition, or coating, depending on the nature of the material.

Second Embodiment of the Invention

The second embodiment of the invention is shown in FIG. 3. As shown, the display device 100′ has a sealing member 50, such as a UV curable adhesive, disposed on the substrate 10 at the area surrounding the display element (26, 24, 22) and the barrier 30. A plate 42 made of a suitable hardness material is laid above the barrier 30 and is connected to the substrate by the adhesive. Again, the hardness of the plate 42 must be at least 2.5 on the Moh's hardness scale. When the adhesive is cured, the display element is hermetically sealed from the atmosphere by the plate 42, the substrate 10 and the sealing member 50. Preferably, the plate 42 is separated from the display element by an air gap 60.

Third Embodiment of the Invention

The third embodiment of the invention is shown in FIG. 4. As shown, the display device 100″ has a thin layer of sealing material 52, such as a UV curable adhesive, disposed on top of the barrier 30. A plate 42 made with a high hardness material is secured to barrier and the display element by the sealing material. When the adhesive is cured, the plate 42 and the barrier 30 form a protective structure for the display.

In the above embodiments, most metals can be used to produce the scratch-resistant layer. The preferred polymers for use to produce the scratch-resistant layer 40, 42 include acrylic plastic, plastic steel, and epoxy resin. As for the first embodiment, the scratch resistant cover 40 can be made of platinum, titanium and ceramic in a sputtering process, for example. Other processes suitable for producing the scratch resistant cover 40 are: chemical vapor deposition of Kelvar, Lexan and lucite, for example; plasma enhanced chemical vapor deposition (PECVD) of ceramic, for example; dipping (similar to electroplating) for producing a layer of metal such as Cu, Ag; and spin-coating of polymers.

In sum, the present invention provides a display device wherein a scratch-resistant layer (40, 42) is disposed in relationship to the electroluminescent display element (26, 24, 22) so as to protect the display element against physical damages such as dust particles, metal debris, and accidental scratching by finger nails. The fabrication process of the device, in general, involves the disposing of a display element on a substrate, and the disposing of the scratch-resistant layer over and/or surrounding the display element. A moisture/oxygen barrier can be provided between the scratch-resistance layer and the display element. Adhesive can be used to provide a hermetic seal for display element and to secure the scratch-resistant layer to the display device. As shown in FIG. 5, a typical electroluminescent display device has a plurality of pixels arranged in a two-dimensional array. One of the pixels is shown in FIG. 5. The pixel comprises a switching TFT M1 and a driving TFT M2. The switching TFT M1 is controlled by the signals in a scan line and signals (V data) in a data line. These signals are provided by a Data ASIC. The source and the drain of the TFT M2 are connected to a DC power source.

It is to be understood that the above-described arrangements are only illustrative of the principles of the present invention. Although the invention has been described and illustrated with respect to exemplary embodiments thereof, the foregoing and various other additions and omissions may be made therein without departing from the scope of the present invention, and the appended claims are intended to cover such modifications and arrangements.

What is claimed is:

1. A display device, comprising:
a substrate,
an electroluminescent display element disposed on the substrate, and
a scratch resistant layer disposed in relationship to the display element, wherein the scratch resistant layer is made of a material having a hardness level of at least 2.5 on Moh's hardness scale.

2. The display device of claim 1, further comprising a barrier layer disposed between the display element and the scratch resistant layer.

3. The display device of claim 2, further comprising a sealing element for securing the scratch resistant layer to the substrate.

4. The display device of claim 3, wherein the sealing element is adapted to form a hermetic seal surrounding the display element and the barrier layer.

5. The display device of claim 3, wherein the scratch resistant layer is separated from the barrier layer by a predetermined gap.

6. The display device of claim 2, further comprising a sealing element for securing the scratch resistant layer to the barrier layer.

7. The display device of claim 1, wherein the scratch resistant layer is made of a polymer disposed on the display element.

8. The display device of claim 1, wherein the scratch resistant layer comprises a metal layer.

9. The display device of claim 1, wherein the scratch resistant layer comprises a ceramic layer.

10. The display device of claim 1, wherein the scratch resistant layer has a thickness substantially equal to or greater than 10 μm.

11. A method of producing a display device, comprising the steps of:
disposing an electroluminescent display element on a substrate, and
disposing a scratch resistant layer in relationship to display element, wherein the scratch resistant layer has a hardness level at least 2.5 on Moh's hardness scale.

12. The method of claim 11, further comprising the step of:
disposing one or more layers of thin films over the display element.

13. The method of claim 11, further comprising the step of:
disposing a sealing element surrounding the display element.
